(19) United States
(12) Patent Application Publication
(10) Pub. No.: US 2024/0360303 A1
(43) Pub. Date: Oct. 31, 2024

(54) Method of Preparing Modified Propylene-Based Polymer and Modified Propylene-Based Polymer Prepared Thereby

(71) Applicants: SK Innovation Co., Ltd., Seoul (KR); SK Geo Centric Co., Ltd., Seoul (KR)

(72) Inventors: Sung Jae Na, Daejeon (KR); Myung Jun Park, Daejeon (KR); Hyo Seung Park, Daejeon (KR); Jun Won Baek, Daejeon (KR)

(73) Assignees: SK Innovation Co., Ltd., Seoul (KR); SK Geo Centric Co., Ltd., Seoul (KR)

(21) Appl. No.: 18/372,294

(22) Filed: Sep. 25, 2023

(30) Foreign Application Priority Data
Apr. 25, 2023 (KR) 10-2023-0053838

(51) Int. Cl. C08L 23/26; C08F 212/36; C08F 236/20; C08K 5/14; C08L 23/12

(52) U.S. Cl. CPC C08L 23/26; C08F 212/36; C08F 236/20; C08K 5/14; C08L 23/12

(57) ABSTRACT

Provided are a method of preparing a modified propylene-based polymer using a radical initiator in a solution state, and a modified propylene-based polymer prepared by the method. Since the modified propylene-based polymer prepared by the method according to some embodiments has less xylene soluble content and includes a long chain branch (LCB) uniformly, it may have improved processability and/or productivity.

### CROSS-REFERENCE TO RELATED APPLICATION

This application claims priority to Korean Patent Application No. 10-2023-0053838, filed Apr. 25, 2023, the disclosure of which is hereby incorporated by reference in its entirety.

### BACKGROND OF THE INVENTION

### Field of the Invention

The present disclosure relates to a method of preparing a modified propylene-based polymer and a modified propylene-based polymer prepared thereby.

### Description of Related Art

Since a polypropylene (PP) polymer is composed of only carbon and hydrogen and has low density, it is easily reproduced, and may implement excellent chemical resistance and high tensile modulus even at relatively low costs. As a method for further improving the physical properties of a propylene polymer, a method of introducing a long chain branch (LCB) to the main chain of the polymer has been performed.

As a technology for adding a long chain branch to the propylene main chain, methods such as solid phase reaction, reactive extrusion, and electron beam irradiation have been reported. Meanwhile, a conventional technology using reaction extrusion often causes main chain cleavage due to a relatively high reaction temperature, thereby deteriorating physical properties.

### SUMMARY OF THE INVENTION

In some embodiments of the present disclosure, there is provided a method of modifying a propylene-based polymer using a radical initiator in a solution state and a modified propylene-based polymer prepared thereby.

In some embodiments of the present disclosure, there is provided a modified propylene-based polymer having a decreased xylene soluble content.

In some embodiments of the present disclosure, there is provided a foaming composition comprising the modified propylene-based polymer according to some embodiments disclosed herein.

In some embodiments, a method of preparing a modified propylene-based polymer comprises: adding a propylene polymer, a diene compound, and a radical initiator to a solvent to prepare a mixture; and subjecting the mixture to a radical reaction.

In some embodiments, a modified propylene-based polymer prepared by the preparation method according to the implementation is provided.

In some embodiments, a modified propylene-based polymer having a xylene soluble content adjusted to 2.0 wt % or less is provided.

In some embodiments, a foaming composition comprises: a modified propylene-based polymer prepared by the preparation method according to the implementation.

Other features and aspects will be apparent from the following detailed description, the drawings, and the claims.

### DESCRIPTION OF THE INVENTION

Since the embodiments described in the present specification may be modified in many different forms, the technology according to one implementation should not be limited to the embodiments set forth herein. Furthermore, throughout the specification, unless otherwise particularly stated, the word “comprise”, “equipped”, “contain”, or “have” does not mean the exclusion of any other constituent element, but means further inclusion of other constituent elements, and elements, materials, or processes which are not further listed are not excluded.

Unless the context clearly indicates otherwise, the singular forms of the terms used in the present specification may be interpreted as including the plural forms. As used herein, the singular form of “a”, “an”, and “the” include plural referents unless the context clearly states otherwise.

The numerical range used in the present specification comprises all values within the range comprising the lower limit and the upper limit, increments logically derived in a form and spanning in a defined range, all double limited values, and all possible combinations of the upper limit and the lower limit in the numerical range defined in different forms. As an example, when it is defined that a content of a composition is 10% to 80% or 20% to 50%, it should be interpreted that a numerical range of 10% to 50% or 50% to 80% is also described in the specification of the present. Unless otherwise defined in the present specification, values which may be outside a numerical range due to experimental error or rounding off of a value are also comprised in the defined numerical range.

For the purposes of this specification, unless otherwise indicated, all numbers expressing quantities of ingredients, reaction conditions, dimensions, physical characteristics, and so forth used in the specification and claims are to be understood as being modified in all instances by the term “about.” Hereinafter, unless otherwise particularly defined in the present specification, “about” may be considered as a value within 30%, 25%, 20%, 15%, 10%, 5%, 3%, 2%, 1%, 0.5%, 0.1%, 0.05% or 0.01 of a stated value. Unless indicated to the contrary, the numerical parameters set forth in the following specification and attached claims are approximations that can vary depending upon the desired properties sought to be obtained by the present invention.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

As used herein, “formed from” or “prepared from” denotes open, e.g., “comprising,” claim language. As such, it is intended that a composition “formed from” or “prepared from” a list of recited components be a composition comprising at least these recited components or the reaction product of at least these recited components, and can further comprise other, non-recited components, during the composition's formation or preparation. As used herein, the phrase “reaction product of” means chemical reaction product(s) of the recited components, and can include partial reaction products as well as fully reacted products.

Unless otherwise particularly defined in the present specification, a “polymer” refers to a molecule which has a relatively high molecular weight, and its structure may comprise multiple structural units of the same or different types and/or multiple repetition of a unit derived from a low molecular weight material or monomer. Examples of polymers include oligomers, homopolymers and copolymers. The term “oligomer” means a polymer consisting of only a few monomer units up to about ten monomer units, for example a dimer, trimer or tetramer. In some embodiments, the polymer may be an alternating copolymer, a block copolymer, a random copolymer, a graft copolymer, a gradient copolymer, a branched copolymer, a crosslinked copolymer, or a copolymer comprising all of them (for example, a polymer comprising more than one monomer). In some embodiments, the polymer may be a homopolymer (for example, a polymer comprising one monomer).

A “propylene-based polymer” used in the present specification is a polymer polymerized from a monomer comprising propylene. A monomer used for preparing the propylene-based polymer according to the present specification necessarily comprises propylene, but the kind of monomer which may be further used is not limited. For example, the propylene-based polymer may be a polymer polymerized from monomers comprising propylene and additional aliphatic unsaturated hydrocarbons (olefin, diene) and the like. Meanwhile, the term “propylene-based polymer” may be also referred to as “propylene polymer” depending on the choice of a person skilled in the art.

In some embodiments, there is provided a method of preparing a modified propylene-based polymer (or a method of modifying a propylene-based polymer) using a radical reaction in a solution state. The method of preparing a modified propylene-based polymer provided in some embodiments has improved uniformity of the reaction by performing the method at a lower temperature than a conventional method using reactive extrusion. The modified propylene-based polymer prepared by the method according to some embodiments may be a long chain branched polypropylene (LCBPP) having a uniform long chain branch. In the modified propylene-based polymer according to some embodiments, various kinds of long chain branches are evenly distributed and a xylene soluble content is low, so that physical properties such as high melt strength, processability, and/or productivity may be excellently implemented.

Hereinafter, a method of preparing a modified propylene-based polymer according to some embodiments and a modified propylene-based polymer prepared therefrom will be described in detail.

In some embodiments, there is provided a method of preparing a modified propylene-based polymer comprising: adding a propylene polymer, a diene compound, and a radical initiator to a solvent to prepare a mixture; and subjecting the mixture to a radical reaction to form the modified propylene-based polymer.

In some embodiments, the step of preparing the mixture may comprise: dissolving a propylene polymer in a solvent; and adding a diene compound and a radical initiator to the solution in which the propylene polymer is dissolved, and then mixing.

In some embodiments, the step of preparing a mixture and/or the step of subjecting to radical reaction may be performed, for example, at 80° C. to 200° C., 80° C. to 180° C., 100° C. to 150° C., or about 130° C., however, the present disclosure is not necessarily limited to these ranges.

In some embodiments, the step of preparing a mixture and the step of subjecting to a radical reaction may be performed under the same temperature conditions. For example, the step of dissolving a propylene polymer in a solvent, the step of adding a diene compound and a radical initiator and then mixing them, and the step of subjecting to a radical reaction may be all performed at the same temperature conditions.

Since the method of preparing a modified propylene-based polymer according to one embodiment may be performed at a lower temperature than the temperature of the method of preparing a modified propylene-based polymer by conventional reactive extrusion, the economic feasibility of the reaction is improved.

In some embodiments, the propylene polymer (that is, polymer before modification) may be isotactic polypropylene (iPP), syndiotactic polypropylene (sPP), atactic polypropylene (aPP), or mixtures thereof. Without being bound by a certain theory, since an isotactic propylene polymer has excellent crystallinity, it may be more appropriate. The isotactic propylene polymer may be prepared using a Ziegler-Natta catalyst or a metallocene catalyst.

In some embodiments, the Ziegler-Natta catalyst (or Ziegler-Natta-based catalyst) may comprise transition metal compounds comprising Group 4, Group 5, or Group 6 elements of the periodic table; and organometal compounds comprising a Group 13 element of the periodic table. The transition metal compound is a main catalyst of the Ziegler-Natta catalyst and may be a compound comprising any one or more of magnesium, titanium, a halogen element, and/or an internal electron donor. The organometal compound is a cocatalyst of the Ziegler-Natta catalyst and may be an organoaluminum compound, and for example, may comprise any one or more of trialkyl aluminum, dialkyl aluminum halide, alkyl aluminum dihalide, aluminum dialkyl hydride, and/or alkyl aluminum sesquihalide. In some embodiments, the organoaluminum compound may be Al(C₂H₅)₃, Al(C₂H₅)₂H, Al(C₃H₇)₃, Al(C₃H₇)₂H, Al(i-C₄H₉)₂H, Al(C₈H₁₇)₃, Al(C₁₂H₂₅)₃, Al(C₂H₅)(C₁₂H₂₅)₂, Al (i-C₄H₉)(C₁₂H₂₅)₂, Al(i-C₄H₉)₂H, Al(i-C₄H₉)₃, (C₂H₅)₂AlCl, (i-C₃H₉)₂AlCl, or (C₂H₅)₃Al₂Cl₃.

In some embodiments, as the propylene polymer before modification which is added in some embodiment, a recycled propylene polymer may be used.

In some embodiments, the propylene polymer may be in a homopolymer or random form, and specifically, may be a homoisotactic propylene polymer or a random isotactic propylene polymer. The homo-type has high fluidity and the random type has a low melting point. Since a homo-or random propylene polymer often has xylene soluble (which may be understood as a content of atactic propylene polymer comprised in the isotactic polymer) of usually more than 5%, it is difficult to use the polymer commercially. Regarding this, some embodiments of the present disclosure provide a modification method which may excellently decrease the xylene content of the propylene polymer.

In some embodiments, the solvent is a solvent for dissolving the propylene polymer, and may comprise any one or more of an aliphatic hydrocarbon compound(s) and/or an aromatic hydrocarbon compound(s). For example, the aliphatic hydrocarbon compound may be a C₃₋₂₀ aliphatic hydrocarbon compound, a C₅₋₁₅ aliphatic hydrocarbon compound, and/or a C₅₋₁₀ aliphatic hydrocarbon compound, may be a chain or cyclic compound, and/or may comprise a ketone group or a hydroxyl group. The aliphatic hydrocarbon compound may be a substituted or unsubstituted compound. In some embodiments, the aliphatic hydrocarbon compound may be substituted with one or more hydroxyl groups; alkoxy groups; alkenyl groups, and/or amino groups. In some embodiments, the aliphatic hydrocarbon compound may be butane, pentane, hexane, heptane, octane, nonane, decane, cyclopentane, cyclohexane, cyclopentane substituted with a C₁₋₅ alkyl group, and/or cyclohexane substituted with a C₁₋₅ alkyl group, or mixtures thereof. The aromatic hydrocarbon compound may be, for example, a C₅₋₂₀ aromatic hydrocarbon compound, C₆₋₂₀ aromatic hydrocarbon compound, C₆₋₁₅ aromatic hydrocarbon compound, C₆₋₁₀ aromatic hydrocarbon compound, and/or C₆₋₈ aromatic hydrocarbon compound. The aromatic hydrocarbon compound may be a substituted or unsubstituted compound. In some embodiments, the aromatic hydrocarbon compound may be substituted with one or more of an alkyl groups, such as methyl or ethyl; hydroxyl groups; alkoxy groups; alkenyl groups, such as ethenyl (vinyl); and/or amino groups. In some embodiments, the aromatic hydrocarbon compound may be benzene, toluene, xylene, cresol, anisole, catechol, naphthalene, styrene, aniline, xylenol or mixtures thereof.

In some embodiments, the diene compound may be added at 0.1 wt % to 20.0 wt %, 0.5 wt % to 15.0 wt %, 1.0 wt % to 20.0 wt %, 1.0 wt % to 15.0 wt %, 2.0 wt % to 15.0 wt %, 3.0 wt % to 15.0 wt %, 3.0 wt % to 13.0 wt %, 5.0 wt % to 20.0 wt %, 5.0 wt % to 15.0 wt %, or 5.0 wt % to 10.0 wt %, based on the weight of the added propylene polymer (that is, when the weight of the propylene polymer is 100 wt %). However, the weight range is only an example, and the present disclosure is not necessarily limited thereto.

In some embodiments, the radical initiator may be added at 0.1 wt % to 5.0 wt %, 0.1 wt % to 3.0 wt %, 0.1 wt % to 2.0 wt %, 0.1 wt % to 1.0 wt %, 0.3 wt % to 1.2 wt %, or about 0.5 wt %, based on the weight of the added propylene polymer. However, the weight range is only an example, and the present disclosure is not necessarily limited thereto.

In some embodiments, a weight ratio between the radical initiator and the diene compound may be 1:1 to 1:50, 1:1 to 1:30, 1:1 to 1:20, 1:2 to 1:20, 1:5 to 1:20, 1:8 to 1:20, or 1:10 to 1:20. However, the weight ratio range is only an example, and the present disclosure is not necessarily limited thereto.

The diene compound according to one embodiment is not particularly limited as long as it is a compound comprising two double bonds, and may be, for example, a compound comprising 2 to 20 carbon atoms, 5 to 10 carbon atoms, 5 to 15 carbon atoms, or 5 to 10 carbon atoms. In some embodiments, the compound may comprise any one or more of 1,3-butadiene, 1,4-pentadiene, 1,5-hexadiene, 1,6-heptadiene, 1,7-octadiene, 1,8-nonadiene, 1,9-decadiene, 1,10-undecadiene, 1,11-dodecadiene, 1,12-tridecadiene, 1,13-tetradecadiene, chloroprene, cyclohexadiene, cyclopentadiene, 2,3-dimethylbutadiene, isoprene, o-divinylbenzene, m-divinylbenzene, and/or p-divinylbenzene, or mixtures thereof. As an example, divinylbenzene (DVB) used in the following example is a mixture of m-DVB and p-DVB.

In some embodiments, the radical initiator may be a known radical initiator without limitation, and may comprise for example, any one or more radical initiators selected from the group consisting of acyl peroxide, alkyl peroxide, hydroperoxide, perester, peroxycarbonate and mixtures thereof.

The acyl peroxide may be, for example, benzoyl peroxide, 4-chlorobenzoyl peroxide, 3-methoxybenzoyl peroxide, and/or methyl benzoyl peroxide.

The alkyl peroxide may be, for example, allyl t-butyl peroxide, 2,2-bis(t-butylperoxybutane), 1,1-bis(t-butylperoxy)-3,3,5-trimethylcyclohexane, n-butyl-4,4-bis(t-butylperoxy) valerate, diisopropylaminomethyl-t-amyl peroxide, dimethylaminomethyl-t-amyl peroxide, diethylaminomethyl-t-butyl peroxide, dimethylaminomethyl-t-butyl peroxide, 1,1-di(t-amylperoxy) cyclohexane, t-amyl peroxide, t-butylcumyl peroxide, t-butyl peroxide, and/or 1-hydroxybutyl n-butyl peroxide.

The perester and the peroxydcarbonate may be, for example, butyl peracetate, cumyl peracetate, cumyl perpropionate, cyclohexyl peracetate, di-t-butyl peradipate, di-t-butyl perazelate, di-t-butyl perglutarate, di-t-butyl perthalate, di-t-butyl percebacate, 4-nitrocumyl perpropionate, 1-phenylethyl peroxybenzoate, 1-phenylethyl 4-nitro-peroxybenzoate, t-butylbicyclo-(2,2,1)heptane peroxycarboxylate, t-butyl-4-carbomethoxy peroxybutyrate, t-butylcyclobutane peroxycarboxylate, t-butylcyclohexyl peroxycarboxylate, t-butylcyclopentyl peroxycarboxylate, t-butylcyclopropane peroxycarboxylate, t-butyldimethyl percinnamate, t-butyl-2-(2,2-diphenylvinyl) peroxybenzoate, t-butyl-4-methoxy peroxybenzoate, t-butyl peroxybenzoate, t-butyl peroxyisopropylcarbonate, t-butyl pertoluate, t-butyl-1-phenylcyclopropyl peroxycarboxylate, t-butyl-2-propylperpenten-2-oate, t-butyl-1-methylcyclopropyl peroxycarboxylate, t-butyl-4-nitrophenyl peracetate, t-butylnitrophenyl peroxycarbanate, t-butyl-N-succiimido peroxycarboxylate, t-butyl perchrotonate, t-butyl permaleic acid, t-butyl permethacrylate, t-butyl peroctoate, t-butyl peroxyisopropylcarbonate, t-butyl perisobutyrate, t-butyl peracrylate, and/or t-butyl perpropionate.

The modified propylene-based polymer prepared by the method according to one embodiment may comprise 2.0 wt % or less, 1.5 wt % or less, 1.0 wt % or less, 0.8 wt % or less, 0.7 wt % or less, 0.5 wt % or less, 0.3 wt % or less, or 0.1 wt % or less of xylene solubles (XS). Herein, the lower limit may be, for example, 0.1 wt %, 0.05 wt %, or 0.01 wt %. The xylene soluble refers to a soluble part in cold xylene of the constituents comprised in the polymer, and may be measured by dissolving a polymer in xylene and then crystallizing an insoluble part (residue) from a cooling solution. Specifically, the xylene soluble may be calculated from the following Equation 1:

$$Xylene soluble ( XS , \% ( wt \% ) ) = \{ ( {m}_{0} - {m}_{1} ) / {m}_{0} \} \times 100 \qquad [ Equation 1 ]$$

wherein m₀ is an initial weight (g) of a polymer, and m₁ is a weight (g) of a residue. The xylene soluble comprises a polymer chain having low stereoregularity, and may be an indicator of an amount of a non-crystalline region.

A modified propylene-based polymer prepared by the preparation method according to some embodiments has a significantly decreased xylene soluble, thereby having excellently improved processability and/or productivity.

In some embodiments, there is provided a modified propylene-based polymer prepared by the preparation method disclosed herein.

The modified propylene-based polymer according to some embodiments may be a multi-branched propylene-based polymer, e.g., a propylene backbone (main chain) may have many side chains, and some of the side chains may further have additional side chains themselves.

In some embodiments, the modified propylene-based polymer may be a long chain branched polypropylene (LCBPP). The modified polymer according to some embodiments has a long chain branch, so that rheological properties such as flow, shear, and/or extension may be excellent.

When the modified propylene-based polymer according to some embodiments is analyzed using gel permeation chromatography, its molecular distribution may be as broad as or broader than that of commercially available LCBPP. That is, the modified propylene-based polymer according to some embodiments is distributed as being not separated from each other but homogeneous.

The modified propylene-based polymer according to some embodiments may comprise a xylene soluble (XS) content at 2.0 wt % or less, 1.5 wt % or less, 1.0 wt % or less, 0.8 wt % or less, 0.7 wt % or less, 0.5 wt % or less, 0.3 wt % or less, or 0.1 wt % or less, as calculated according to Equation 1.

Since the modified propylene-based polymer according to some embodiments has a high melt strength, it may be used to prepare a blown film, extrusion coating, foam extrusion, blow molding, or the like. In addition, due to its high melt strength, processability, productivity, and/or the like may be much improved, and due to the increased melt strength at a high temperature, foam molding at a high temperature is allowed. Since the modified propylene-based polymer may be recycled, it is useful as an environmentally friendly lightweight material.

The modified propylene-based polymer according to some embodiments has high melt strength and excellent physical properties, and thus, may be used in manufacture of foaming articles such as a laminated or non-laminated sheet, beads, or a demolding material. In some embodiments, the modified propylene-based polymer is used to form an article by thermoforming, injection molding, blow molding, extrusion coating, or melting. In some embodiments, the modified propylene-based polymer may be effectively applied to various fields such as adhesives, films, or packaging materials.

Some embodiments of the present disclosure provides a modified propylene-based polymer having a xylene soluble content of 2.0 wt % or less.

The modified propylene-based polymer according to some embodiments has a significantly decreased xylene soluble content (calculated according to Equation 1), and thus, has excellent physical properties, such as excellent productivity and/or processability.

The modified propylene-based polymer according to some embodiments may comprise 1.5 wt % or less, 1.0 wt % or less, 0.8 wt % or less, 0.7 wt % or less, 0.5 wt % or less, 0.3 wt % or less, or 0.1 wt % or less of the xylene soluble. Herein, the lower limit may be, for example, 0.1 wt %, 0.05 wt %, or 0.01 wt %.

The modified propylene-based polymer according to some embodiments may have a crystallization temperature (Tc) of 110° C. to 124° C. as measured according to DSC measurement conditions according to the following experimental examples. In some embodiments, the crystallization temperature may be 110° C. to 120° C. or 110° C. to 118° C.

The modified propylene-based polymer according to some embodiments may have a number average molecular weight (Mn) of 60,000 g/mol to 110,000 g/mol as measured according to the GPC measurement conditions according to the following experimental examples. In some embodiments, the number average molecular weight may be 70,000 g/mol to 110,000 g/mol.

The modified propylene-based polymer according to some embodiments may have a strain hardening index (SHI) of 0.2 or more, 0.3 or more, 0.5 or more, 1.0 or more, 1.5 or more, 1.8 or more, or 1.9 or more as measured in ranges of a Hencky rate (dε/dt) of 1.0 s⁻¹ and a Hencky strain (ε) of 1 to 3 at 180° C. Herein, the upper limit of the strain hardening index may be, for example, 5.0, 4.0, 3.0, or 2.74.

The strain hardening index is defined as a gradient value (c2) of a common log function (log (ε)) of Hencky strain defined by the following Equation 2:

$${η}_{E} = c 1 \times {ε}^{c 2} \qquad [ Equation 2 ]$$

wherein η_{E} is an elongation viscosity (Pa·s), ε is Hencky strain, and c1 and c2 are parameters.

The propylene-based polymer according to some embodiments shows an excellent strain hardening index which is equal to or higher than a conventionally developed product, and it is recognized therefrom that the modified propylene-based polymer according to some embodiments comprises various long chain branches. Therefore, when the propylene-based polymer according to such embodiments are used, a stable state may be effectively maintained during processing.

The modified propylene-based polymer according to some embodiments may be prepared by copolymerizing a diene comonomer, or the above description of the diene compound may be applied.

In some embodiments, there is provided a foaming composition comprising the modified propylene-based polymer and a foam molded body formed using the composition, and the use of the molded body is not particularly limited.

In some embodiments, there is provided a method of preparing a modified propylene-based polymer comprising: dissolving a propylene polymer in a solvent under an inert gas, such as nitrogen, until the propylene polymer is dissolved in the solvent; and adding a diene compound and a radical initiator to the solution in which the propylene polymer is dissolved, and then mixing to form a mixture. The mixture is stirred and subjected to a radical reaction at the same or a different temperature. The product may be cooled to room temperature, washed with acetone, and filtered and dried to obtain a modified propylene-based polymer. Suitable reaction conditions and components are disclosed in detail herein.

Hereinafter, the examples and the experimental examples will be illustrated in detail. However, since the examples and the experimental examples described later only illustrate a part of one embodiment, the technology described in the present specification should not be construed as being limited thereto.

### EXAMPLE 1

15 g of a propylene polymer (isotactic polypropylene, iPP) and a magnetic bar were put into a 500 mL 3-neck round bottom flask, 300 mL of an n-octane solvent was added thereto, and a reflux was performed with nitrogen gas at 120° C. After the propylene polymer was all dissolved, 1.0 wt % of octadiene and 1.0 wt % of DVB (Sigma-Aldrich) as a diene monomer, and 0.5 wt % of TBPB as a radical initiator were added, and stirring was performed at the same temperature for 1 hour. It was cooled down to room temperature, washed with acetone, and filtered and dried to obtain a modified propylene-based polymer.

### EXAMPLES 2 TO 7

Propylene polymers were modified in the same manner as in Example 1, except that the solvent, the radical initiator, and the diene as listed in the following Table 1 were used.

TABLE 1

| | | Radical initiator | | Diene | |
|---|---|---|---|---|---|
| | | | Content | | Content |
| Example No. | Solvent | Type | (wt %) | Type | (wt %) |
| 1 | Octane | TBPB | 0.5 | 1.7- | 1.0/1.0 |
| | | | | octadiene/DVB | |
| 2 | Xylene | TBPB | 0.5 | DVB | 2.0 |
| 3 | Xylene | LP | 0.5 | DVB | 2.0 |
| 4 | Xylene | TBPB | 0.5 | DVB | 0.5 |
| 5 | Xylene | TBPB | 0.5 | DVB | 5.0 |
| 6 | Octane | TBPB | 0.5 | DVB | 5.0 |
| 7 | Xylene | TBPB | 0.5 | DVB | 10.0 |

(wt % was based on the weight of the propylene polymer)
TBPB: t-butyl peroxybenzoate
LP: lauroyl peroxide
DVB: divinylbenzene

### COMPARATIVE EXAMPLE 1

The propylene polymer before modification (isotactic polypropylene, iPP) which was used in Example 1 was prepared.

### COMPARATIVE EXAMPLE 2

WB140HMS (available from Borealis) which is a high melt strength propylene polymer (HMSPP) was prepared. WB140HMS is a product manufactured by reactive extrusion.

### <EXPERIMENTAL EXAMPLE 1> MEASUREMENT OF XYLENE SOLUBLE (XS) CONTENT

A xylene soluble content was measured using Crystex. Specifically, it was measured by dissolving a modified propylene-based polymer in xylene, and then crystallizing an insoluble part (residue) from a cooling solution. The xylene soluble content was calculated by the following Equation 1. The results are shown in the following Table 2:

$$Xylene soluble ( XS , \% ( wt \% ) ) = \{ ( {m}_{0} - {m}_{1} ) / {m}_{0} \} \times 100 \qquad [ Equation 1 ]$$

wherein m₀ is an initial weight (g) of a polymer, and m₁ is a weight (g) of a residue.

### <EXPERIMENTAL EXAMPLE 2> DIFFERENTIAL SCANNING CALORIMETRY (DSC) ANALYSIS

Differential scanning calorimetry (DSC) was used to measure a crystalline temperature (Tc) and a melting temperature (Tm) of the polymer. A polymer specimen was prepared by pressing it with a crimper press for DSC analysis, and was analyzed at a temperature of −50° C. to 200° C. and a heating rate of 10° C./min. The results are shown in the following Table 2.

### <EXPERIMENTAL EXAMPLE 3> GEL PERMEATION CHROMATOGRAPHY (GPC) ANALYSIS

Gel permeation chromatography (GPC) was used to confirm a molecular weight distribution of the polymer, and the results are shown in the following Table 2. For GPC analysis, Polymer Char GPC-IR equipment was used (standard sample: Easical PS1 Polystyrene, temperature: 160° C., solvent: 1,2,4-Trichlorobenzene, viscosity constant: K, α of polypropylene). About 1.5 mg of the polymer sample was placed to a 1.25 mL high temperature GPC vial, 1 mL of 1,2,4-trichlorobenzene (w/BHT) was added thereto, dissolution was performed for 3 hours or more with stirring at 150° C., and the solution was used for analysis.

### <EXPERIMENTAL EXAMPLE 4> ELONGATION VISCOSITY ANALYSIS

In order to confirm the strain hardening properties of the polymer, elongation viscosity over time was measured. The measurement for elongation viscosity analysis was performed by using a strain-controlled rheometer (ARES) available from TA, preparing a polymer as a specimen having a thickness of 8 mm and a width of 10.2 mm under the conditions of 180° C. and a strain rate of 1.0 s⁻¹, and setting a final Hencky strain to 3.5.

In order to numerically confirm the strain hardening properties of the polymer, a strain hardening index (SHI) defined as a gradient value (c2) of a common log (log (ε)) function of a Hencky strain (ε) defined by the following Equation 2 was calculated, and the results are shown in the following Table 2:

$${η}_{E} = c 1 \times {ε}^{c 2} \qquad [ Equation 2 ]$$

wherein η_{E} is an elongation viscosity (Pa·s) measured at a Hencky rate (dε/dt) of 1.0 s⁻¹ at 180° C., the measurement being performed in a Hencky strain (ε) range of 1 to 3, and c1 and c2 are parameters. The parameters c1 and c2 were confirmed by floating a log function of the Hencky strain (log (η_{E})=c2×log (ε)+log (c1)) and applying a least square method to linear fit the data.

TABLE 2

| | XS | Tc | Tm | Mn | Mw | | |
|---|---|---|---|---|---|---|---|
| | (wt %) | (° C.) | (° C.) | (kg/mol) | (kg/mol) | MWD | SHI |
| Example 1 | 0.52 | 112.58 | 159.85 | 72.2 | 371.0 | 5.13 | 0.76 |
| Example 2 | 0.07 | 118.60 | 161.17 | 86.0 | 398.0 | 4.63 | 0.47 |
| Example 3 | 0.79 | 116.57 | 164.67 | 89.2 | 453.0 | 5.08 | 0.50 |
| Example 4 | 0.26 | 117.69 | 167.92 | 77.1 | 385.0 | 4.99 | 0.21 |
| Example 5 | 0.62 | 118.57 | 164.09 | 87.5 | 390.0 | 4.46 | 1.97 |
| Example 6 | 0.43 | 117.02 | 166.31 | 77.8 | 429.0 | 5.51 | 2.56 |
| Example 7 | 0.08 | 116.50 | 165.02 | 106.0 | 413.0 | 3.89 | 2.74 |
| Comparative | 3.2 | 110.94 | 160.89 | 129.0 | 471.0 | 3.64 | 0.26 |
| Example 1 | | | | | | | |
| Comparative | 2.5 | 124.50 | 161.50 | 71.7 | 421.0 | 5.86 | 2.75 |
| Example 2 | | | | | | | |

From the above experiments, it was found that all of the modified propylene-based polymers prepared by the method according to the examples had a xylene soluble content of about 1.0 wt % or less which is significantly lower than that of the comparative examples, and thus, it was confirmed that a polymer having excellent crystallinity, heat resistance, and excellent mechanical strength may be prepared by modification of the propylene polymer according to the examples.

In addition, the propylene-based polymer modified by the method according to the examples showed a molecular weight distribution as broad as that of a commercially available propylene-based polymer (Comparative Example 2), and thus, it was found that the polymers were not separated, were homogeneously distributed, and had a high distribution.

In addition, the propylene-based polymer modified by the method according to the examples showed a strain hardening index which is similar to that of the commercially available propylene-based polymer (Comparative Example 2) and better than that of the propylene-based polymer of Comparative Example 1. Thus, it was confirmed that a polymer which has excellent strain hardening properties and may effectively maintain a stable state during processing may be prepared.

The present disclosure relates to a method of preparing a modified propylene-based polymer using a radical initiator in a solution state, and a modified propylene-based polymer prepared by the method. Since the modified propylene-based polymer prepared by the method according to one implementation has less xylene soluble content and comprises a long chain branch (LCB) uniformly, it may have improved processability and/or productivity.

Hereinabove, though one implementation has been described in detail by the examples and the experimental examples, the scope of one embodiment is not limited to specific examples, and should be construed by the appended claims.

1. A method of preparing a modified propylene-based polymer, the method comprising:
adding a propylene polymer, a diene compound, and a radical initiator to a solvent to prepare a mixture; and
subjecting the mixture to a radical reaction.

2. The method of preparing a modified propylene-based polymer of claim 1, wherein the preparing of the mixture comprises:
dissolving the propylene polymer in the solvent; and
adding the diene compound and the radical initiator and performing mixing.

3. The method of preparing a modified propylene-based polymer of claim 1, wherein the preparing of the mixture and the subjecting to a radical reaction are each performed at a temperature of 80° C. to 200° C.

4. The method of preparing a modified propylene-based polymer of claim 1, wherein the solvent comprises any one or more of aliphatic hydrocarbon compound(s) and/or aromatic hydrocarbon compound(s).

5. The method of preparing a modified propylene-based polymer of claim 4, wherein the aliphatic hydrocarbon compound is a C₃₋₂₀ aliphatic hydrocarbon compound.

6. The method of preparing a modified propylene-based polymer of claim 4, wherein the aromatic hydrocarbon compound is a C₅₋₂₀ aromatic hydrocarbon compound.

7. The method of preparing a modified propylene-based polymer of claim 1, wherein the diene compound is added at 0.1 wt % to 20.0 wt % based on the weight of the added propylene polymer.

8. The method of preparing a modified propylene-based polymer of claim 1, wherein a weight ratio between the radical initiator and the diene compound is 1:1 to 1:50.

9. The method of preparing a modified propylene-based polymer of claim 1, wherein the radical initiator is added at 0.1 wt % to 5.0 wt % based on the weight of the added propylene polymer.

10. The method of preparing a modified propylene-based polymer of claim 1, wherein the diene compound is a compound comprising 2 to 20 carbon atoms.

11. The method of preparing a modified propylene-based polymer of claim 1, wherein the diene compound comprises any one or more selected from the group consisting of 1,3-butadiene, 1,4-pentadiene, 1,5-hexadiene, 1,6-heptadiene, 1,7-octadiene, 1,8-nonadiene, 1,9-decadiene, 1,10-undecadiene, 1,11-dodecadiene, 1,12-tridecadiene, 1,13-tetradecadiene, chloroprene, cyclohexadiene, cyclopentadiene, 2,3-dimethylbutadiene, isoprene, o-divinylbenzene, m-divinylbenzene, p-divinylbenzene and mixtures thereof.

12. The method of preparing a modified propylene-based polymer of claim 1, wherein the modified propylene-based polymer has 2.0 wt % or less of a xylene soluble.

13. A modified propylene-based polymer prepared by the method of preparing a modified propylene-based polymer according to claim 1.

14. The modified propylene-based polymer of claim 13, wherein the modified propylene-based polymer has 2.0 wt % or less of a xylene soluble.

15. A modified propylene-based polymer having a xylene soluble content of 2.0 wt % or less.

16. The modified propylene-based polymer of claim 15, wherein the modified propylene-based polymer has a crystallization temperature (Tc) of 110° C. to 124° C.

17. The modified propylene-based polymer of claim 15, wherein the modified propylene-based polymer has a number average molecular weight (Mn) of 60,000 g/mol to 110,000 g/mol.

18. The modified propylene-based polymer of claim 15, wherein the modified propylene-based polymer has a strain hardening index (SHI) of 0.2 or more as measured in ranges of a Hencky rate (dε/dt) of 1.0 s⁻¹ and a Hencky strain (ε) of 1 to 3 at 180° C., the strain hardening index being defined as a gradient value (c2) of a common log (log (ε)) function of the Hencky strain defined by the following Equation 2:
$${η}_{E} = c 1 \times {ε}^{c 2} \qquad [ Equation 2 ]$$
wherein η_{E} is an elongation viscosity (Pa·s), ε is Hencky strain, and c1 and c2 are parameters.

19. The modified propylene-based polymer of claim 15, wherein the modified propylene-based polymer is prepared by copolymerizing a diene comonomer.

20. A foaming composition comprising the modified propylene-based polymer according to claim 14.
